(19) United States
(12) Patent Application Publication
(10) Pub. No.: US 2005/0102196 A1
(43) Pub. Date: May 12, 2005

(54) Electronic purchasing method and corresponding apparatus

(76) Inventor: Yoco Hung, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/982,071

(22) Filed: Nov. 5, 2004

(30) Foreign Application Priority Data
Nov. 10, 2003 (TW) 92131440

(51) Int. Cl. G06F 17/60

(52) U.S. Cl. 705/26

(57) ABSTRACT

An electronic purchasing method including at least the following steps is disclosed. Produce an electronic purchasing requisition. Then computer automatically send the purchasing requisition to the authorizing supervisor of the applicant for approval. Next, determine whether a part number of the part to be purchased is shown on the electronic purchasing requisition or not. Then, determine whether the part number is a contracted part number or not. Then, make inquiries and collect quotations. Next, process general part treatment and produce a temporary purchasing order. The purchasing order is automatically sent to the purchasing department to be approved and ordered.

This application claims the benefit of Taiwan application Serial No. 92131440, filed Nov. 10, 2003, the subject matter of which is incorporated herein by reference.

### BACKGROUND OF THE INVENTION

1. Field of the Invention

The invention relates in general to an electronic purchasing method, and more particularly to a purchasing method capable of increasing office efficiency.

2.Description of the Related Art

Cost reduction is very crucial if a business wish to improve its competitive edges. For example, simplifying the office routines is a good way to reduce the cost, hence improving the competitive edges.

A purchasing requisition needs to be completed in a conventional purchasing process. However, when filling in the purchasing requisition, since an applicant has not knowledge about whether the company has ever purchased the same item or not, it is very difficult for the applicant to avail himself or herself of the past experiences accumulated in the company in estimating the purchasing price or selecting most suitable model for the company. The applicant has to go to the purchasing department to consult heaps of documents, but the purchasing personnel might happen to be not at the office. The applicant might adopt a rough estimate of the purchasing price in filling the requisition form. Afterwards, if the purchasing personnel make an inquiry and receives a quotation higher than the applicant's estimate of the purchasing price, the applicant needs to re-do the procedure of filling a purchasing requisition and have the purchasing requisition countersigned by an authorizing supervisor again.

Suppose the applicant wishes to visit the purchasing department to find out required information before filling and sending the purchasing requisition to the authorizing supervisor, however, the purchasing process still might be delayed, causing the applicant to be distracted, if the authorizing supervisor happens to be unavailable or not at the office. On the other hand, if the purchasing requisition has been approved and the part number of the part to be purchased has been given, the purchasing department will inquire the suppliers. If anyone would like to understand the processing of the purchase, he or she has to make a phone call to inquire the purchasing personnel who might happen to be unavailable, out of the office or in the office but the purchasing requisition is not at their hand. These scenarios reduce office efficiency, hence the increase in cost.

Therefore an urgent need of a thorough solution to resolve the problem disclosed above comes to the fore.

### SUMMARY OF THE INVENTION

The invention provides an electronic purchasing method capable of saving cost and increasing office efficiency.

The electronic purchasing method according to the invention at least includes the following steps. Produce an electronic purchasing requisition by receiving a part name of the part to be purchased at least. The computer automatically send the purchasing requisition to the authorizing supervisor of the applicant for approval: if approved, proceed to the next step; if disapproved, return to the previous step of producing an electronic purchasing requisition or terminate the purchasing process. Determine whether a part number of the part to be purchased is shown on the electronic purchasing requisition or not: if yes, proceed to the next step; if not, proceed to the step of checking whether the part number can be found in the historic records or not. Determine whether the part number is a contracted part number or not: if not, proceed to the next step; if yes, process contracted part treatment. Make inquiries and collect quotations. Process general part treatment, during which, if the quotation from the intended supplier is higher than the price approved by the applicant's authorizing supervisor, proceed to the step of automatically sending the purchasing requisition to the authorizing supervisor for approval first before proceeding to the next step. Produce a temporary purchasing order: proceed to the next step if the purchasing code in the temporary purchasing order is “Y” (or any determined value), otherwise correct or cancel the temporary purchasing order. The purchasing order is automatically sent to the purchasing department to be approved and ordered.

Following the step of automatically sending the purchasing requisition to the purchasing department to be approved and ordered, the purchasing method according to the invention continues the following steps: placing a purchasing order, receiving the delivered part, and sending an e-mail to notify the applicant to perform acceptance check. If the received part is accepted, proceed to the next step, otherwise, return to the step of receiving the delivered part again and automatically inform the authorizing supervisor of the outcome of acceptance check by sending an e-mail for instance.

the outcome in the step of determining whether a part number of the part name is shown on the electronic purchasing requisition or not is negative, proceed to the step of checking whether the part number can be found in historic records or not. If yes, proceed to the step of determining whether the part number is a contacted part number or not; if not, proceed to the next step. At last, assign a part number to the part to be purchased and directly proceed to the step of determining whether the part number is a contracted part number or not after the part number is assigned.

If the outcome in the step of determining whether the part number is a contracted part number or not is affirmative, proceed to the step of processing contracted part treatment. Next, proceed to the step of determining whether to convert the contracted part into a general part or not: if yes, proceed to the step of making inquiries and collecting quotations; if not, proceed to the step of producing a temporary purchasing order.

Before proceeding to the next step, the step of processing general part treatment according to the invention further comprises, for instance, returning the purchasing order to the applicant and waiting for the applicant's response to provide that the part to be purchased is in short supply, that another model is recommended by the supplier, that the part to be purchased is not on the market yet, or that a specific delivery date is unavailable.

Before proceeding to the next step, the step of general part treatment further comprises the following steps. If the part to be purchased needs to be countersigned by relevant departments, refer the purchasing order to relevant departments and wait until an approval is gained before proceeding to the next step. Report the quoted price to the authorizing supervisor of the applicant and reply the CEO's comments should there be any before proceeding to the next step.

Other contents, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flowchart of an electronic purchasing method according to a preferred embodiment of the invention;

FIG. 2 is a flowchart of a purchasing process annexed to the flowchart of the purchasing method in FIG. 1; and

FIG. 3 is a structure of a purchasing system corresponding to FIG. 1 and FIG. 2.

### DETAILED DESCRIPTION OF THE INVENTION

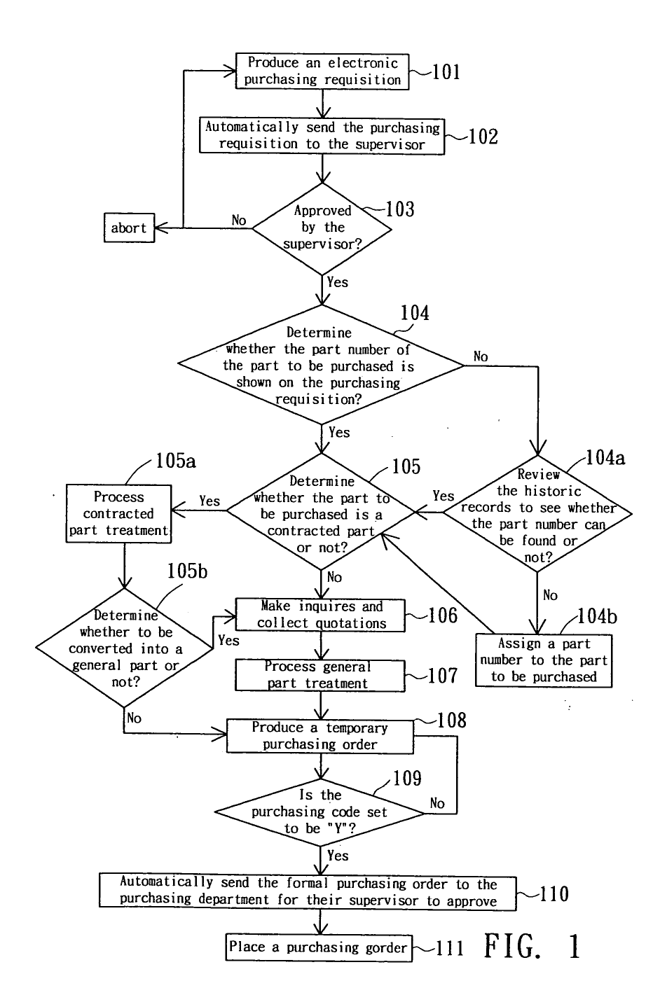

Referring to FIG. 1, a flowchart of an electronic purchasing method according to a preferred embodiment of the invention is shown. First of all, produce an electronic purchasing requisition in step 101. An applicant of the purchase of a part may produce an electronic purchasing requisition by inputting related information of the part to be purchased, i.e. the part name, price, supplier, etc., to an electronic form of a purchase processing interface of a purchasing system. Of the above pieces of information inputted, only the part name is a compulsory requirement in an electronic purchasing requisition.

Before filling in the electronic purchasing requisition, the applicant may conveniently consult a purchase history database of a purchasing system to find out all records related to the purchase of the same part made by other staff. Availed by these historic records in the electronic database, the applicant will thus be able to input the information regarding suitable suppliers and valuable estimates of price. This step may dispense with tedious procedures of making inquiries and collecting prices, not only saves the processing time and help the purchasing personnel to increase their efficiency, but also reduces the applicant's waiting time.

After the electronic purchasing requisition is produced, proceed to the step 102 of automatically sending the purchasing requisition to an authorizing supervisor for approval by the purchasing system. The purchasing system determines to whom the purchasing requisition should be sent according to a personnel authorization database and automatically sends the electronic purchasing requisition by a purchase status instant notice routine. For example, the purchasing system will provide the authorizing supervisor of the applicant with his or her authorized limit of approval by the purchase status instant notice routine. The electronic purchasing requisition may be sent to the authorizing supervisor via e-mail, text, autodial, bulletin board system, etc. Using the purchasing system to replace the conventional practice of countersigning in person dispenses with the tedious process of locating each other, saving the staff tremendous time and energy.

In the next step, if the requisition is disapproved by the authorizing supervisor, the applicant may choose to abort the requisition or proceed to step 101 to make corrections and create a new purchasing requisition. If the authorizing supervisor approves the purchasing requisition and agrees with the upper limit of purchase, proceed to step 104.

In the step 104 of determining whether a part number of a part name is shown on the electronic purchasing requisition or not, if the part number is shown, proceed to step 105, otherwise proceed to the step 104a of checking whether the part number of the part to be purchased can be found in the purchase history database of the purchasing system or not. Same part shares same part number, so the purchasing personnel can easily determine whether the company has ever purchased the same part or not. If the company has purchased the same part, the purchasing personnel may check whether the company has stock of the part or not. If stock of the part is available, the applicant may use the stock directly without waiting for the delivery of the purchase. However, if the part number cannot be found in the purchase history database, the purchasing personnel may check again to find out the truth. There are many possibilities, for example, the part number may never exist, or the part number may exist but the applicant cannot locate it or the applicant may have got the part number wrong. The part number is checked and assured in step 104a.

If the part number cannot be found, proceed to the step 104b of assigning a part number to the part to be purchased. Assigning a part number means the company has never had purchased this part. Next, proceed to step 105 after step 1 04b is completed.

Step 105 determines whether the part number is a contracted part number or not according to a supplier contract database of the purchasing system. If the company has already signed a contract with the supplier of the part to be purchased, the purchasing process may be dispensed with tedious red tape such as quotation inquiring, negotiation, etc. Therefore, if the part to be purchased is a contract supply part, proceed to step 105a of processing contracted part treatment.

If the part to be purchased is not a contract supply part, proceed to step 106 to make inquiries and collect quotations. In this step, the purchasing personnel will inquire several potential suppliers to find out most suitable models and best prices.

Next, proceed to step 107 to process general part treatment. This step, which treats some possible scenarios, occurs when the market has been studied but the purchasing order has not yet been placed. This step includes several options corresponding to various scenarios. For example, if the quoted price of the intended supplier is higher than the authorized limit of the authorizing supervisor of the applicant, the purchasing order will be sent to the authorizing supervisor for approval again and has to wait until the authorized limit of the authorizing supervisor has been increased before proceeding to the next step. If the part to be purchased needs to be countersigned by relevant departments, then the purchasing system will refer the purchasing requisition to relevant departments and wait until an approval is gained by means of a purchase status instant notice routine before proceeding to the next step. The purchasing system may be requested to report the collected quotations of prices to the applicant's supervisor. These scenarios are processed in the present step. Moreover, the present step may process some special requests. For example, the CEO may comment on some purchases he or she is concerned about. The CEO's concerns must be replied before proceeding to the next step.

There are some scenarios that may arise due to market factors. For example, it may happen that the part to be purchased is in short supply, that another model is recommended by the supplier, that the part to be purchased is not on the market yet, or that a specific delivery date is unavailable. Under these circumstances, the purchasing requisition needs to be returned to the applicant and wait for the applicant's response before proceeding to the next step.

After the above scenarios have been settled, proceed to step 108. In step 108 to produce a temporary purchasing order after determining the product to be purchased.

Back to step 105a, after the contracted part treatment is completed, it may still happen that the part supplied by a contracted supplier is not of the exact model requested by the applicant or that the contracted supplier is in short supply of the particular model requested by the applicant, the purchasing requisition of a contracted part treatment may be converted into a general part treatment in step 105b and proceed to the step 106 of making inquires and collecting quotations as disclosed above. If the processing of contracted pat treatment runs smoothly, then directly proceed to the step 108 of producing a temporary purchasing order.

The temporary purchasing order has a purchasing code indicating whether the temporary purchasing order still remains in the purchasing personnel's system or not, so the purchasing personnel may make necessary changes to the temporary purchasing order or convert the temporary purchasing order into a formal purchasing order for the supervisor of the purchasing department to review and approve. In step 109, if the purchasing code in the temporary purchasing order is “Y” (or any determined value), the temporary purchasing order will be converted into a formal purchasing order, then proceed to the next step of automatically sending the formal purchasing order to the supervisor of the purchasing department for approval. On the other hand, if the purchasing code in the temporary purchasing order is “N” (or another determined value), the purchasing personnel still may make changes to the temporary purchasing order to produce a temporary purchasing order anew.

Next, proceed to step 110, the purchase status instant notice routine of the purchasing system automatically sends the formal purchasing order to the supervisor of the purchasing department for approval. Proceed to step 111, the purchasing personnel places the purchasing order to the chosen supplier. The first half of the purchasing process ends here.

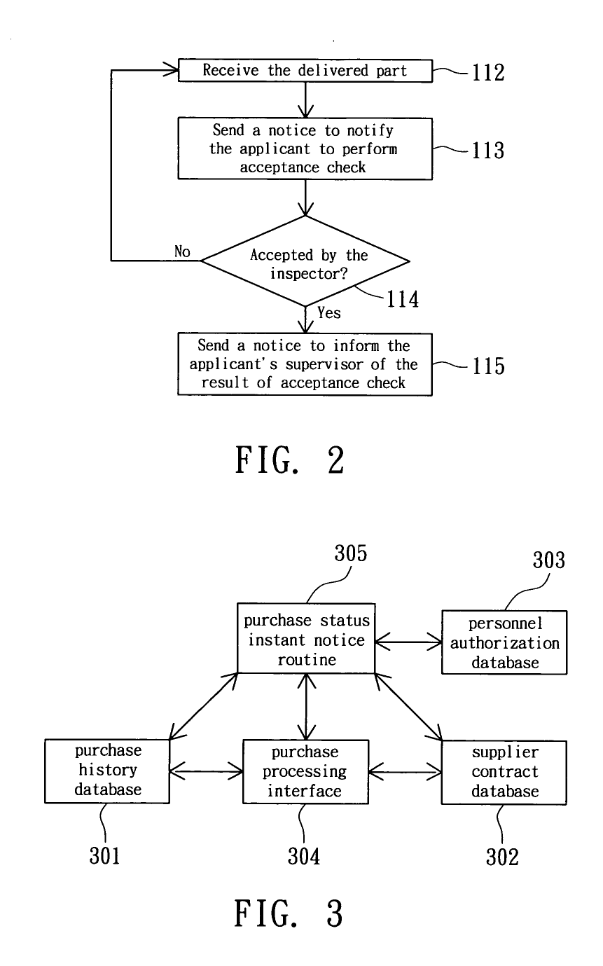

Referring to FIG. 2, a flowchart of a purchasing process annexed to the flowchart of the purchasing method in FIG. 1 is shown. The second half of the purchasing process mainly focuses on acceptance check. Firstly, in the step 112 of receiving delivered part, the supplier has delivered the ordered part to the company for the purchasing personnel to check and decide whether accept. Next, in step 113, the purchase status instant notice routine notifies the applicant of the purchase of the part to perform acceptance check on the part. The applicant may be notified via e-mail, text, autodialing or bulletin board system etc. In step 114, the staff will perform acceptance check to assure whether the delivered part is acceptable or not. If there are any problems with the delivered part, the supplier will be requested to deliver the part again, and step 112 of receiving delivered part will be repeated. If the delivered part is accepted, proceed to the step 115 of informing the applicant's supervisor of the outcome of the acceptance check. Now the whole purchasing process is completed. The data during the purchasing process are also recorded in the purchase history database for the reference of future purchase. During the purchasing process, the user of the purchasing system, by means of the purchasing system, may easily inquire the current status of purchase processing or inform the applicant of the current status. The whole purchasing process only involves the participation of the applicant, the purchasing department and relevant supervisors; otherwise the purchasing process is processed by the purchasing system automatically without involving other personnel's participation. The purchasing system may flexibly inform the staff of the current status via e-mail, texts, telephone or bulletin board system.

The electronic purchasing process of an electronic purchasing system according to the invention as shown in FIG. 3 at least includes a purchase history database 301, a supplier contract database 302, a personnel authorization database 303, a purchase processing interface 304 and a purchase status instant notice routine 305. The purchase history database 301 collects the historic data of the purchased parts for the reference of future purchase. The supplier contract database 302 stores the data of the contracted supplier of the parts. The personnel authorization database 303 stores the scope and limit of authorization of the personnel involved in the purchasing process, for instance, to what limit a supervisor is authorized to approve. The purchase processing interface 304 provides interface for the whole purchasing process. For example, to create a new purchasing requisition, to inquire the historic data of a part to be purchased, or to facilitate a user to inquire any information related to the purchase whenever and wherever the user want to. The purchase status instant notice routine 305 gives timely notice to relevant personnel at each stage during the purchasing process and further coordinates the purchase history database 301, the supplier contract database 302, the personnel authorization database 303 and the purchase processing interface 304. For example, the purchase status instant notice routine 305 updates the purchase history database 301 and/or the supplier contract database 302 according to the process and result of a purchase. It is noteworthy that not any particular programming language or commercial database software is specified in the invention. Any computer software will do as long as the above disclosed functions are satisfied.

From the above disclosure, it is understood that the electronic purchasing system and the method thereof not only saves costs, but also at least has the following advantages:

1. The purchasing system may inquire the historic records of the same part number of the purchase history database to find out the past experiences accumulated in the company whereby the applicant may come to a reasonable estimate of price, lest the purchasing requisition might be disapproved due to an over-estimated price or the purchasing requisition might need to go through the approving process again and again due to an under-estimated amount of purchase.

2. The purchase history database of the purchasing system may also help the purchasing personnel to improve their efficiency for the purchasing personnel may directly inquire those suppliers who have had business with the company without searching the market again.

3. Using the computer to send documents to be countersigned by supervisors or staff of the same department or different departments alike saves the staff tedious labor and time spent on locating each other, so the staff may be more concentrated on their work

4. The processing time since the purchase of a part is requested till the part is checked and accepted is further shortened, so the applicant does not need to waist his or her time waiting for the part, lest his or her work might be delayed due to a long period of waiting.

5. Except for the signature of the applicant and those who countersign the application, the remaining process may be done by the computer automatically without using any other personnel's participation. According to various databases, the purchasing system may use a computer program to determine whether relevant policies are met or not and to determine whether a certain relevant person needs to be notified or not. For example, a computer program may send documents to relevant personnel and inform them of the current status or record relevant information during the purchasing process.

6. In short, the invention may improve office efficiency and improve the competitive edges of the company.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An electronic purchasing method, comprising at least the steps of:
producing an electronic purchasing requisition by a user by receiving an inputted part name of the part to be purchased at least;
automatically sending the purchasing requisition to the authorizing supervisor of the applicant for approval by the computer: if approved, proceed to the next step; if disapproved, return to the previous step or abort the purchasing process;
automatically determining whether a part number of the part to be purchased is shown on the electronic purchasing requisition or not: if yes, proceed to the next step; if not, proceed to the step of reviewing the historic records to determine the part number of the part to be purchased;
determining whether the part number is a contracted part number or not: if not, proceed to the next step; if yes, process contracted part treatment;
making inquiries, collecting quotations and recording the acquired information by the user;
automatically processing general part treatment, during which, if the quotation from the intended supplier is higher than the price approved by the applicant's authorizing supervisor, proceed to the step of sending the purchasing requisition to the authorizing supervisor for approval automatically before proceeding to the next step;
automatically producing a temporary purchasing order: if the purchasing code in the temporary purchasing order is a determined value, convert the temporary purchasing order to a formal purchasing order and proceed to the next step, otherwise correct or cancel the temporary purchasing order; and
automatically sending the purchasing order to the supervisor of the purchasing department for the purchasing order to be approved and ordered.

2. The electronic purchasing method according to claim 1, wherein following the step of automatically sending the purchasing order to the purchasing department for the purchasing order to be approved and ordered, the method further comprises:
placing a purchasing order;
receiving the delivered part;
notifying the applicant to perform acceptance check: if the received part is accepted, proceed to the next step, otherwise, return to the step of receiving the delivered part again, wherein possible ways of notice comprise e-mail, text, telephone and bulletin board system; and
informing the authorizing supervisor of the outcome of acceptance check, wherein possible ways of notice comprise e-mail, text, telephone and bulletin board system.

3. The electronic purchasing method according to claim 1, wherein the step of reviewing historic data further comprises:
automatically checking whether the part number can be found in historic records or not: if yes, proceed to the step of determining whether the part number is a contacted part number or not, otherwise proceed to the next step;
assigning a part number to the part to be purchased and directly proceed to the step of determining whether the part number is a contracted part number or not after the part number is assigned.

4. The electronic purchasing method according to claim 1, wherein if the outcome in the step of determining whether the part number is a contracted part number or not is affirmative, proceed to the following steps of:
processing contracted part treatment; and
determining whether to convert the contracted part into a general part or not: if yes, proceed to the step of making inquiries and collecting quotations, otherwise proceed to the step of producing a temporary purchasing order.

5. The electronic purchasing method according to claim 1, wherein the step of processing general part treatment further comprises:
returning the purchasing order to the applicant and waiting for the applicant's response before proceeding the next step if the part to be purchased is in short supply.

6. The electronic purchasing method according to claim 1, wherein the step of processing general part treatment further comprises:
returning the purchasing order to the applicant and waiting for the applicant's response before proceeding the next step if another model is recommended by the supplier.

7. The electronic purchasing method according to claim 1, wherein the step of processing general part treatment further comprises:
returning the purchasing order to the applicant and waiting for the applicant's response before proceeding the next step if the part to be purchased is not on the market yet.

8. The electronic purchasing method according to claim 1, wherein the step of processing general part treatment further comprises:
returning the purchasing order to the applicant and waiting for the applicant's response before proceeding the next step if a specific delivery date is unavailable.

9. The electronic purchasing method according to claim 1, wherein the step of processing general part treatment further comprises:
referring the purchasing order to relevant departments and wait until an approval is gained before proceeding to the next step if the part to be purchased needs to be countersigned by relevant departments.

10. The electronic purchasing method according to claim 1, wherein the step of processing general part treatment further comprises:
reporting the quoted price to the authorizing supervisor of the applicant.

11. The electronic purchasing method according to claim 1, wherein the step of processing general part treatment further comprises:
replying the CEO's comments should there be any before proceeding to the next step.

12. An electronic purchasing system, comprising at least:
a purchase history database for collecting the data of at least a purchased part for the reference of future purchase;
a supplier contract database for storing the data of at least a contracted supplier of the parts;
a personnel authorization database for storing the scope and limit of authorization of the personnel involved in the purchasing process; and
a purchase processing interface for allowing at least one user to use the purchasing system; and
a purchase status instant notice routine for giving timely notice to relevant personnel at each stage during the purchasing process and further coordinating the purchase history database, the supplier contract database, the personnel authorization database and the purchase processing interface.

13. The purchasing system according to claim 12, wherein the purchase status instant notice routine determines whom to notify according to the personnel authorization database.

14. The purchasing system according to claim 12, wherein the purchase status instant notice routine notifies relevant personnel via e-mail, text, telephone or bulletin board system.

15. The purchasing system according to claim 12, wherein the purchase status instant notice routine updates the purchase history database according to the process and result of a purchase.

16. The purchasing system according to claim 12, wherein the purchase status instant notice routine updates the supplier contract database according to the process and result of a purchase.

17. The purchasing system according to claim 12, wherein the purchase processing interface further facilitates a user to inquire any information related to the purchase whenever and wherever the user want to.

18. The purchasing system according to claim 12, wherein the purchase processing interface further facilitates a user to create a new purchasing requisition, inquire historic data of the part to be purchased, etc.
